(19) United States
(12) Patent Application Publication
(10) Pub. No.: US 2012/0270652 A1
(43) Pub. Date: Oct. 25, 2012

(54) SYSTEM FOR SERVICING GAME STREAMING ACCORDING TO GAME CLIENT DEVICE AND METHOD

(75) Inventors: Sung-Soo KIM, Daejeon (KR); Kyoung Ill Kim, Seoul (KR); Choong Gyoo Lim, Daejeon (KR); Jong Ho Won, Daejeon (KR); Chang Joon Park, Daejeon (KR); Byoung Tae Choi, Daejeon (KR)

(73) Assignee: Electronics and Telecommunications Research Institute, Daejeon (KR)

(21) Appl. No.: 13/452,785

(22) Filed: Apr. 20, 2012

(30) Foreign Application Priority Data
Apr. 21, 2011 (KR) 10-2011-0037468

(51) Int. Cl. A63F 13/00

(52) U.S. Cl. 463/32; 463/34

(57) ABSTRACT

Disclosed is a system for servicing game streaming, including: a server for servicing streaming game configured to receive game input data and hardware performance information from a user terminal device and service video streaming or merging streaming coupling the video streaming and graphics streaming according to the received performance of the user terminal device; and a database configured to store a background screen and characters for a game streaming service of the server for servicing streaming game.

### CROSS-REFERENCES TO RELATED APPLICATIONS

The present application claims priority under 35 U.S.C 119(a) to Korean Application No. 10-2011-0037468, filed on Apr. 21, 2011, in the Korean Intellectual Property Office, which is incorporated herein by reference in its entirety set forth in full.

### BACKGROUND

Exemplary embodiments of the present invention relate to a system and a method for servicing game streaming, and more particularly, to a system and a method for servicing game streaming capable of rapidly processing a motion of characters according to a user input and visualizing the motion of the characters through terminal rendering by selectively merging and transforming video streaming and graphics streaming so as to render user characters in a high level terminal capable of performing rendering and render a background screen in a server when performing game services targeting various types of user terminals.

With the development of Internet and game service technologies, a massively multiplayer online game (MMOG) has been very popular all over the world. Most of the game contents are distributed to users in a game DVD title and a download type. However, these methods have DVD copy, illegal download, or the like.

Recently, with the development of a cloud computing related system and a service technology, a technology of processing various types of software services in a server side has been activated.

Recently, in order to solve an illegal copy for game contents, a system for allowing a server to stream the game contents to provide services has been introduced.

The game streaming mechanism may be classified into a video streaming mechanism of rendering a game screen in a server and then, transmitting the rendered image to a user and a graphics streaming mechanism of transmitting data and rendering command languages required to render the game scene in the server.

The video streaming mechanism of rendering a sharing space like a background and all user characters in the MMOG game in the IS server and then, encoding the result images and providing the encoded images to the user in a stream type. However, the method performs the rendering on a large number of users in the server, which results in increasing the load of the server for performing the rendering processing.

The graphics streaming mechanism can reduce the load of the server for rendering processing by transferring the game scene data and the rendering command language to the user terminal. However, the graphics streaming mechanism has a problem in that the user character data and the data for the game sharing space such as a large background, or the like, need to be transmitted to all the users. One of the fundamental causes of these problems is inefficiency caused by the transmission of a large amount of data such as background, or the like, for generating high-quality game scene.

The above-mentioned technical configuration is a background art for helping understanding of the present invention and does not mean related arts well known in a technical field to which the present invention pertains.

### SUMMARY

An embodiment of the present invention is directed to a system and a method for servicing game streaming according to a game terminal device capable of composing a final screen and providing a final game screen by processing a large amount of background data in a server and rendering each user character in a terminal to compose a final screen.

Another embodiment of the present invention is directed to a system and a method for servicing game streaming capable of solving a problem of a load of a server for rendering processing by selectively merging and transmitting video streaming and graphics streaming capable of rendering user characters in a terminal and rendering a background screen in a server according to hardware performance of a user terminal in a streaming game service for a massively multiplayer online game.

An embodiment of the present invention relates to a system for servicing game streaming, including: a server for servicing streaming game configured to receive game input data and hardware performance information from a user terminal device and service video streaming or merging streaming coupling the video streaming and graphics streaming according to the received performance of the user terminal device; and a database configured to store a background screen and characters for a game streaming service of the server for servicing streaming game.

The server for servicing streaming game may service the merging streaming coupling the video streaming and the graphics streaming when the hardware performance of the user terminal device is a high level that performs rendering.

The server for servicing streaming game may generate the merging streaming by directly rendering the background screen and a sharing scene to generate the video streaming and extracting only rendering command languages for each user character to generate the graphics streaming and by coupling the video streaming with the graphics streaming.

The server for servicing streaming game may include: a client server communication processing unit configured to process communication between the user terminal device and the streaming game service; a rendering execution unit configured to perform the rendering on the background and the sharing scene; a video encoding processing unit configured to encode an image generated by performing the rendering of the rendering execution unit to generate the video streaming; a three-dimensional graphic command language capture unit configured to extract rendering command languages for the user characters to generate the graphics streaming; a streaming mechanism merging processing unit configured to merge the video streaming generated in the video encoding processing unit with the graphics streaming generated in the three-dimensional graphic command language capture unit; and an input receiving processing unit configured to process the game input data and the hardware performance information input from the user terminal device.

An embodiment of the present invention relates to a system IS for servicing game streaming including: a client server communication processing unit configured to process communication between a server for servicing game streaming and a streaming game service; a video decoding processing unit configured to decode video streaming transmitted from the server for servicing game streaming; a rendering execution unit configured to decode graphics streaming transmitted from the server for servicing game streaming to perform rendering command languages for user characters; a final image composition unit configured to compose background images generated in the video decoding processing unit and a character image generated in the rendering execution unit; and a user terminal information input capture and transmission processing unit configured to transmit user terminal information to the server for servicing streaming game.

An embodiment of the present invention relates to a method for servicing game streaming, including: receiving game input data and hardware specification information from a user terminal; determining whether the user terminal device is a high level terminal that implements rendering; and transmitting video streaming or merging streaming coupling the video streaming and graphic streaming to the user terminal device according to the determination result on whether the user terminal device is the high level terminal.

The method may further include: performing rendering on a background and a sharing space when the user terminal device is a high level; generating the video streaming by performing video encoding on rendered images; generating graphics streaming by extracting command languages required for character rendering for each user other than a background; and transmitting merge streaming coupling the video streaming and the graphics streaming to the user terminal device.

The method may further include: rendering the background and the sharing space and all the characters when the user terminal device is a low level; generating video streaming by performing video encoding on rendered images; and transmitting the generated video streaming to the user terminal device.

A method for servicing game streaming includes: receiving video streaming from a server for servicing game streaming; determining whether the received video streaming is merging streaming coupling the video streaming and graphics streaming; generating background images by decoding the video streaming when the received video streaming is the merging streaming as the determination result and generating character images by decoding the graphics streaming to perform rendering command languages on user characters; and composing the generated background images and the generated character images.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram for schematically describing a system for coupling game streaming according to a game terminal device in accordance with an embodiment of the present invention;

FIG. 2 is a processing flow chart of a video streaming mechanism in the system for servicing game streaming in accordance with the embodiment of the present invention;

FIG. 3 is a processing flow chart of a graphics streaming mechanism in the system for servicing game streaming in accordance with the embodiment of the present invention;

FIG. 4 is a diagram for describing a merging game streaming mechanism in accordance with another embodiment of the present invention;

FIG. 5 is a diagram illustrating functional components of a server for servicing streaming game using the merging game streaming mechanism in the embodiment of the present invention and a user terminal apparatus;

FIG. 6 is a flow chart of a process of a merging game streaming mechanism of the server for servicing streaming game in accordance with the embodiment of the present invention; and

FIG. 7 is a flow chart of a process of the merging game streaming mechanism of the user terminal device in accordance with the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

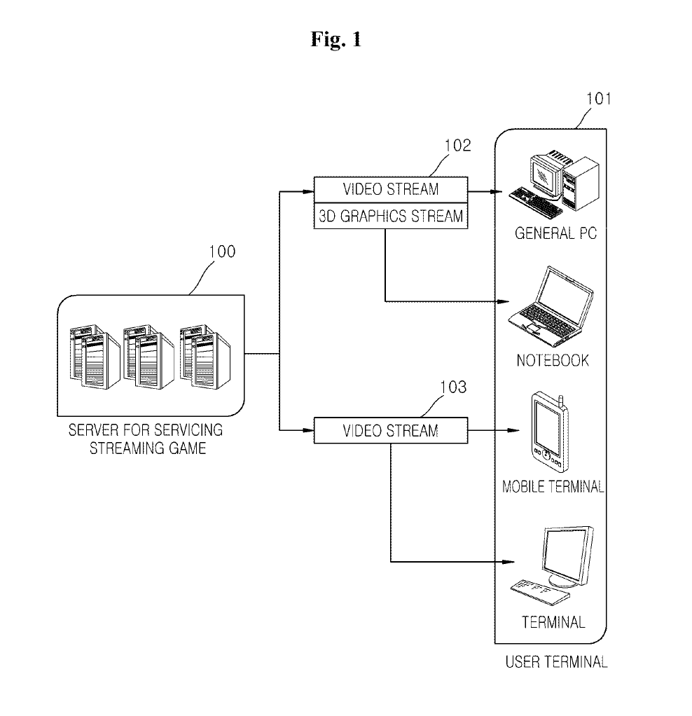

FIG. 1 is a diagram for schematically describing a system for coupling game streaming according to a game terminal device in accordance with an embodiment of the present invention.

Referring to FIG. 1, the system for coupling game streaming in accordance with an embodiment of the present invention includes a server 100 for servicing streaming game and a user terminal device 101.

The server 100 for servicing streaming game performs game service components such as animation, sound generation, provision of an artificial intelligence system function, physical simulation, rendering, or the like, by using a central processing unit (CPU) and a graphic processing unit (GPU) and provides corresponding game result images to a user in a stream type.

The embodiment of the present provides a method for providing and composing a game screen by a streaming merging method among the streaming game service components.

The user terminal device 101 accesses the server 100 for servicing streaming game through various communication networks such as a wired or wireless Internet network to use game services based on the provided streaming.

The user input is transmitted, including the input data for game play and performance information of the user terminal device 101.

Here, the performance information of the user terminal device 101 includes CPU specifications and graphics processing performance (the number of triangles that can perform rendering per second).

In the case of a low level terminal, the server 100 for servicing streaming game uses a video streaming mechanism that performs all the renderings on a game scene in the server and encodes the corresponding images and transmits the encoded images to a video streaming 103 according to the performance information of the user terminal device 101.

The user terminal device 101 decodes the transmitted video streaming and displays the decoded video streaming on a user terminal screen.

In addition, in the case of the high level terminal, the server 100 for servicing streaming game performs the rendering on a sharing space such as background in the server to generate the video streaming, encodes data and rendering command languages for game characters corresponding to the user terminal device 101 to generate 3D graphics streaming, merges the generated 3D graphics streaming with the above-mentioned video streaming, and transmits the merged streaming to the user.

Then, the user terminal device 101 decodes the video streaming corresponding to the background and performs the rendering in the user terminal according to the rendering command languages within the 3D graphic stream, thereby generating images. After the generated images are merged with the already decoded video images, the merged images are displayed on the user terminal screen.

Further, the user terminal device 101 includes a database that stores a background screen for the game streaming service of the server 100 for servicing streaming game and information on characters.

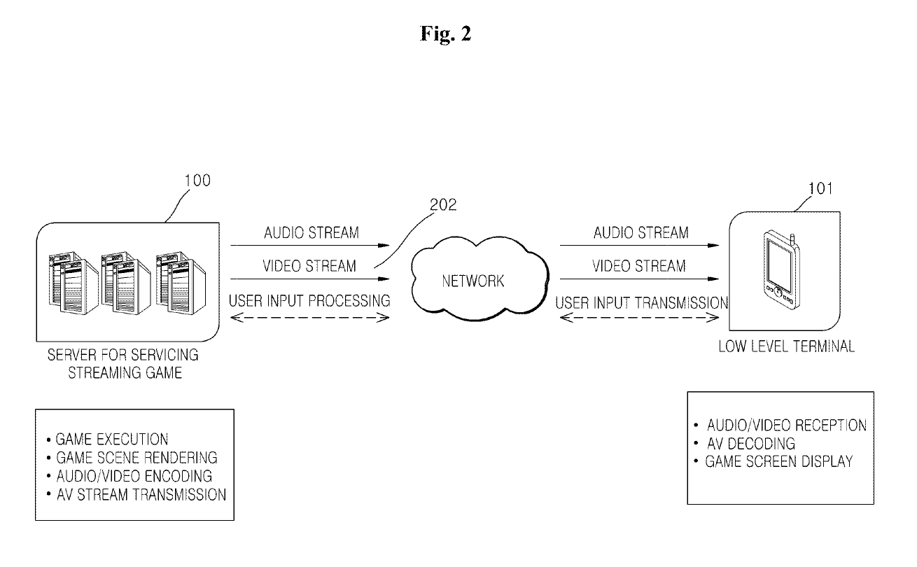

FIG. 2 is a processing flow chart of a video streaming mechanism in the system for servicing game streaming in accordance with the embodiment of the present invention.

Referring to FIG. 2, a game user accesses the server 100 for servicing streaming game to request a game service start and play a game.

The server 100 for servicing streaming game provides game services requested by a user and stores a game input of a user to a user input database. The server 100 analyzes the performance information of the input user terminal device 101 and provides services through a video streaming mechanism in the case of a low level terminal 210.

The video streaming mechanism performs a function of transmitting game execution, a game scene, rendering, audio and video (AV) encoding, and AV stream to a user from the server 100 for servicing streaming game.

Here, in order to implement the AV encoding, the encoding method such as already known MPEG-4, H.264, or the like, may be used.

Video streaming 202 is transmitted to a user through a network. In the low level user terminal 201, the audio and video streaming transmitted from the server 100 for servicing streaming game is decoded and then, is displayed on a user terminal device screen.

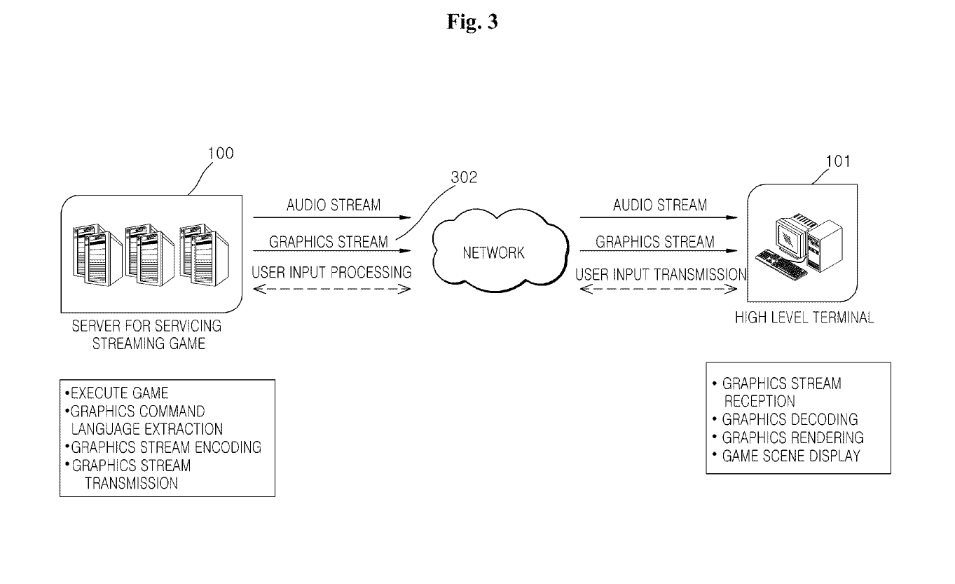

FIG. 3 is a processing flow chart of a graphics streaming mechanism in the system for servicing streaming game in accordance with the embodiment of the present invention.

Referring to FIG. 3, the streaming game service server 100 executes game execution, extraction of the graphics data and command languages, the graphics streaming encoding, a graphics streaming (302) transmitting function.

The big difference between the graphics streaming mechanism and the video streaming mechanism is that the server does not perform the rendering but the terminal performs the rendering by extracting the command languages for performing rendering and transmitting the extracted command languages to the user terminal device 101.

When the user terminal device 101 is the high level terminal 301, the user terminal device 101 decodes the transmitted graphics streaming and performs the rendering according to the corresponding rendering command languages and then, displays the generated images on the terminal device screen.

The video streaming mechanism transmits the continued image frame to the terminal through the video encoding, whereas the graphics streaming mechanism transmits data for rendering and OpenGL or DirectX rendering command languages.

Therefore, the graphics streaming mechanism has an advantage that it has lower data transmission capacity than the video streaming mechanism in terms of the network transmission. However, the user terminal device 101 needs to repeatedly perform the rendering on a background that is not substantially changed every times and a three-dimensional sharing scene space.

The embodiment of the present invention performs the rendering of the overlapping space (background, or the like) in the server 100 for servicing streaming game rather than in the user terminal device 101 and can render only the user characters only in the user terminal device 101.

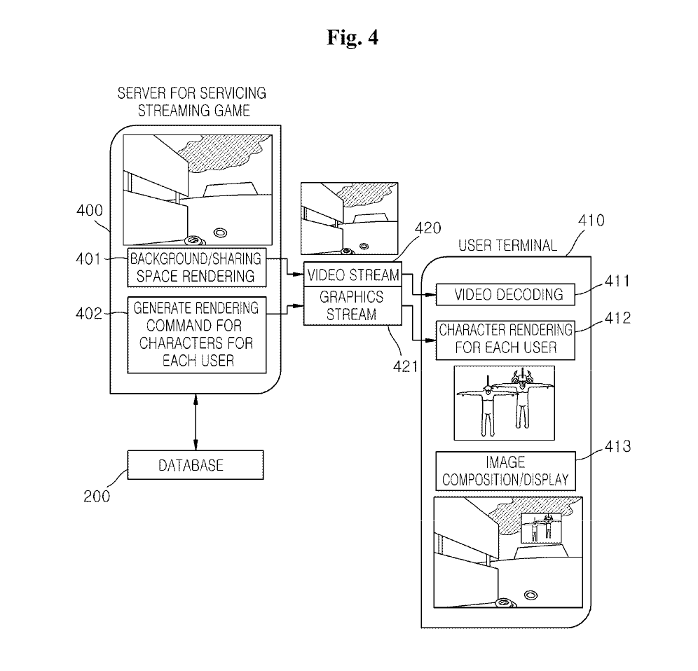

FIG. 4 is a diagram for describing a merging streaming mechanism in accordance with another embodiment of the present invention.

Referring to FIG. 4, the server 100 for servicing streaming game performs rendering 401 on the background and the sharing space and generates video streaming 420 encoding the generated images.

In addition, the server 100 for servicing streaming game extracts (402) the rendering command languages on characters on each game server user to generate graphics streaming 421.

One stream in which the so generated vide streaming 420 and graphics streaming 421 are merged with each other is transmitted to the user terminal device 101.

The user terminal device 101 performs decoding 411 on the video streaming 420 in the transmitted merged stream to obtain the background and the sharing space image. Further, the user terminal device 101 performs character rendering 412 for each user by using the rendering data and the command languages that are obtained by decoding the graphics streaming 421. The terminal composes (413) the images generated by the rendering and the background images generated by the decoding and displays the composed images on the user terminal screen.

As described above, the embodiment of the present invention can reduce a rendering processing response speed for the user characters while reducing the rendering processing load of the server 100 for servicing streaming game by the user character rendering and the image composing function in the user terminal device 101.

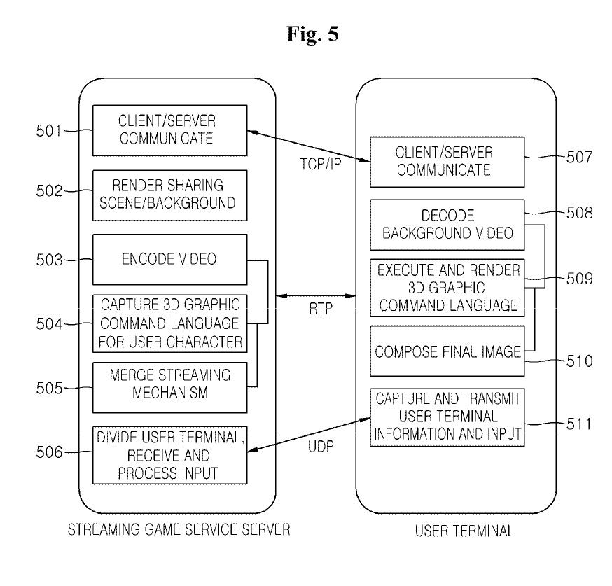

FIG. 5 is a diagram illustrating functional components of a server for servicing streaming game using the merging game streaming mechanism in the embodiment of the present invention and a user terminal apparatus.

Referring to FIG. 5, for communication processing of the streaming game service, the server 100 for servicing streaming game and the user terminal device 101 and client/server communication processing units 501 and 507 included in the user terminal device 101 are provided.

Here, as the protocol for communication, a TCP/IP protocol may be used.

Main functional components of the streaming game service server 100 includes a rendering execution unit 502 that executes rendering on a background and sharing scene, a video encoding processing unit 503 that generates video streaming by encoding the images generated after the rendering, a three-dimensional graphic command language capture unit 504 that extracts the rendering command language for the user characters to generate the three-dimensional graphics streaming, a streaming mechanism merging processing unit 505 that merges the video streaming derived in the video encoding processing unit 503 and the graphics streaming generated in the three-dimensional graphic command language capture unit 504, and an input receiving processing unit 506 that receives and processes game input data and hardware performance information from the user terminal device 101.

Here, the video streaming, the graphics streaming, and the merging stream are transmitted to the user terminal through a real-time protocol (RTP).

Further, the user terminal information and the input are transmitted through a user datagram protocol (UDP) protocol.

The high level user terminal device 101 includes a video decoding processing unit 508 that decodes the video streaming for the background transmitted from the server 100 for servicing streaming game, a rendering execution unit 509 that decodes the graphics streaming transmitted from the server 100 for servicing the game streaming and executes the rendering command languages for the user characters, a final image composition unit 510 that composes the background images generated in the video decoding processing unit 508 and the character image generated in the rendering execution unit 509, and a user terminal information input capture and transmitting processing unit 511 that transmits the user terminal information to the server 100 for servicing streaming game, as the functional components.

Here, the user terminal information includes a CPU type and GPU processing performance information of the user terminal device.

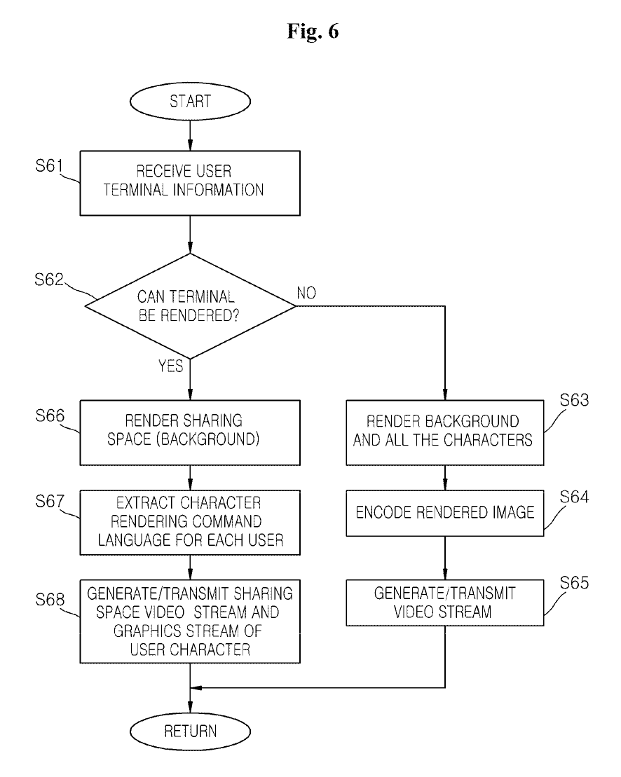

FIG. 6 is a flow chart of a process of a merging game streaming mechanism of the server for servicing streaming game in accordance with the embodiment of the present invention.

Referring to FIG. 6, the user terminal information is first received from the user terminal device (101) (S61).

Next, it is determined whether the user terminal device is the high level user terminal device 101 that can implement the rendering.

In the high level user terminal device, the rendering of the background and the sharing space is performed and then, the result images are subjected to the video encoding (S66).

The command languages (OpenGL or DirectX command languages) required for the character rendering for each user other than the background are extracted (S67).

Next, one stream is generated by merging the generated sharing space video streaming and the graphics streaming of the user characters and then, is transmitted to the user terminal device 101 (S68).

Next, in the case of the low level user terminal device 101, the background and the all the characters are rendered in the server 100 for servicing streaming game (S63).

Next, the rendered images are subjected to the video encoding (S64).

Further, the video streaming is generated and is transmitted to the user terminal device 101 by the video streaming mechanism (S65).

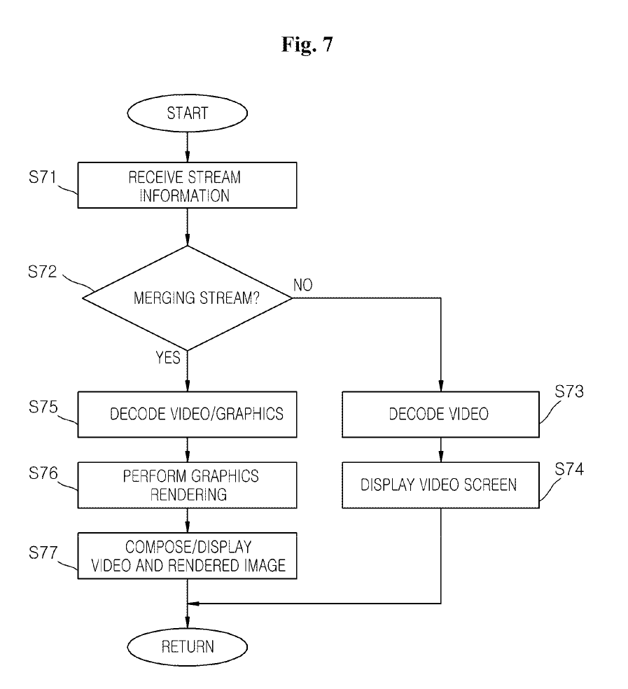

FIG. 7 is a flow chart of a process of the merging game streaming method of the user terminal apparatus in accordance with the embodiment of the present invention.

Referring to FIG. 7, the stream information is first received from the server 100 for servicing streaming game (S71).

The header information of the transmitted stream is read and the recognition of the merging streaming is differentiated (S72).

In the case of the merging stream, the video/graphics streaming is subjected to the decoding (S75).

Next, the rendering is performed according to the character rendering command languages (OpenGL or DirectX command languages) for each user other than the background (S76).

Further, the composition of the generated rendering images and background images is performed and is displayed on the user terminal device screen (S77).

On the other hand, when the transmitted stream is the video streaming, the video decoding is performed (S73) and the decoded images are displayed on the user terminal device screen (S74).

As described above, the embodiment of the present invention selectively merges the stream information transmission mechanisms for transmitting the game images from the server 100 for servicing streaming game according to the performance of a computing terminal device connected to the network and provides the game image to the user.

In summary, according to the hardware performance of the user terminal device 101 in the server 100 for servicing streaming game, for the low level terminal device service, the video streaming mechanism of performing and transmitting all the renderings of the game image in the server 100 for servicing streaming game is provided and for the high level terminal device service, the main sharing space such as the background, or the like, is subjected to the rendering to generate the video streaming and the rendering command languages for the rest user game characters are extracted to generate the graphics streaming and then, merge and transmit the video streaming and the graphics streaming.

The embodiment of the present invention can reduce the load of the server 100 for servicing streaming game for processing the rendering and can provide the rapid response speed to the user by rapidly processing the user character rendering regarding the game execution in the user terminal device 101.

In addition, the embodiments of the present invention generally perform the MMOG game based on the characters of the user, thereby making it possible to provide the character rendering speed faster and at higher quality than the related art.

As described above, the embodiments of the present invention can reduce the response time to the user characters for the user input while reducing the processing load of the server, by performing the merge streaming on the large rendering causing the speed degradation due to the bottle phenomenon in the MMOG-based games operated in the streaming game service to perform the rendering on the user characters in the user terminal.

In addition, the embodiments of the present invention can be applied to the online game service and the remote virtual reality application region in which multiple users participate and to the professional disaster prevention simulation or battle simulation providing fields that are needed to visualize the user characters within the large sharing space rather than the online game user.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A system for servicing game streaming, comprising:
a server for servicing streaming game configured to receive game input data and hardware performance information from a user terminal device and to service video streaming or merging streaming coupling the video streaming and graphics streaming according to the received performance of the user terminal device; and
a database configured to store information about a background screen and characters for a game streaming service of the server for servicing streaming game.

2. The system of claim 1, wherein the server for servicing streaming game services the merging streaming coupling the video streaming and the graphics streaming when the hardware performance of the user terminal device is a high level that performs rendering.

3. The system of claim 1, wherein the server for servicing streaming game generates the merging streaming by directly rendering the background screen and a sharing scene to generate the video streaming and extracting only rendering command languages for each user character to generate the graphics streaming and by coupling the video streaming with the graphics streaming.

4. The system of claim 1, wherein the server for servicing streaming game includes:
a client server communication processing unit configured to process communication between the user terminal device and the streaming game service;
a rendering execution unit configured to perform the rendering on the background and the sharing scene;
a video encoding processing unit configured to encode an image generated by performing the rendering of the rendering execution unit to generate the video streaming;
a three-dimensional graphic command language capture unit configured to extract rendering command languages for the user characters to generate the graphics streaming;
a streaming mechanism merging processing unit configured to merge the video streaming generated by the video encoding processing unit with the graphics streaming generated by the three-dimensional graphic command language capture unit; and
an input receiving processing unit configured to process the game input data and the hardware performance information input from the user terminal device.

5. A system for servicing game streaming, comprising:
a client server communication processing unit configured to process communication between a server for servicing game streaming and a streaming game service;
a video decoding processing unit configured to decode video streaming transmitted from the server for servicing game streaming;
a rendering execution unit configured to decode graphics streaming transmitted from the server for servicing game streaming to perform rendering command languages for user characters;
a final image composition unit configured to compose background images generated in the video decoding processing unit and a character image generated in the rendering execution unit; and
a user terminal information input capture and transmission processing unit configured to transmit user terminal information to the server for servicing streaming game.

6. A method for servicing game streaming, comprising:
receiving game input data and hardware specification information from a user terminal;
determining whether the user terminal device is a high level terminal capable of rendering; and
transmitting video streaming or merging streaming coupling the video streaming and graphic streaming to the user terminal device according to the determination result on whether the user terminal device is the high level terminal.

7. The method of claim 6, further comprising:
performing rendering on a background and a sharing space when the user terminal device is the high level terminal;
generating the video streaming by performing video encoding on rendered images;
generating graphics streaming by extracting command languages required for character rendering for each user other than the background; and
transmitting merge streaming coupling the video streaming and the graphics streaming to the user terminal device.

8. The method of claim 6, further comprising:
rendering the background, the sharing space and all the characters when the user terminal device is a low level terminal;
generating video streaming by performing video encoding on rendered images; and
transmitting the generated video streaming to the user terminal device.

9. A method for servicing game streaming, comprising:
receiving video streaming from a server for servicing game streaming;
determining whether the received video streaming is merging streaming that couples the video streaming and graphics streaming;
generating background images by decoding the video streaming when the received video streaming is the merging streaming as the determination result and generating character images by decoding the graphics streaming to perform rendering command languages on user characters; and
composing the generated background images and the generated character images.
